(19) United States
(12) Patent Application Publication
(10) Pub. No.: US 2009/0271200 A1
(43) Pub. Date: Oct. 29, 2009

(54) Speech recognition assembly for acoustically controlling a function of a motor vehicle

(75) Inventors: Rohit Mishra, Sunnyvale, CA (US); Edward Kim, San Francisco, CA (US)

Correspondence Address: MANFRED BECK PA, PO BOX 431255, SOUTH MIAMI, FL, 33243-1255, US

(73) Assignee: Volkswagen Group of America, Inc., Herndon, VA (US)

(21) Appl. No.: 12/410,430

(22) Filed: Mar. 24, 2009

Related U.S. Application Data
(63) Continuation-in-part of application No. 12/108,264, filed on Apr. 23, 2008.

(51) Int. Cl. G10L 15/00

(52) U.S. Cl. 704/254; 704/275; 704/E15.001

(57) ABSTRACT

The invention relates to a speech recognition assembly for acoustically controlling a function of a motor vehicle, wherein the speech recognition assembly comprises a microphone disposed in the motor vehicle for inputting a voice command, a data base disposed in the motor vehicle in which respectively at least one meaning is allocated to phonetic representations of voice commands and an on-board-speech-recognition-system disposed in the motor vehicle for determining a meaning of the voice command by use of a meaning of a phonetic representation of a voice command stored in the data base, and wherein the speech recognition assembly further comprises an off-board-speech-recognition-system disposed spatially separated from the motor vehicle for determining a meaning of the voice command.

### CROSS-REFERENCE TO RELATED APPLICATIONS

This application is a continuation-in-part of U.S. application Ser. No. 12/108,264, entitled NAVIGATION CONFIGURATION FOR A MOTOR VEHICLE, MOTOR VEHICLE HAVING A NAVIGATION SYSTEM, AND METHOD FOR DETERMINING A ROUTE, filed Apr. 23, 2008.

### BACKGROUND OF THE INVENTION

The invention relates to a speech recognition assembly for acoustically controlling a function of a motor vehicle.

DE 199 42 869 A1 discloses a device for operating a voice controlled means in motor vehicles, wherein voice commands are allocated to a device function in the motor vehicle by speech pattern comparison, wherein additionally to predetermined functions triggerable by voice commands new functions are ad-hoc enabled by ad-hoc-generations and allocations of new speech patterns, and wherein these ad-hoc-generations are conducted by adaptive transcription. According to one embodiment speech patterns can be transmitted and received in the vehicle from extern, for example via telematic services or the World Wide Web such that the on-board-system can “learn” by said access to extern.

DE 10 2006 006 551 A1 discloses a system for providing speech dialog applications on mobile terminals including a server for generating at least one speech dialog application comprising a formal description of a speech dialog programmed in a decription language and a radio transmitter for digitally broadcasting the generated speech dialog applications to radio receivers of mobile terminals located within its broadcasting area.

DE 10 2004 059 372 A1 discloses a navigation system comprising a vehicle modular unit, a voice conversation document generating server and an information locating server.

EP 1 417 456 B1 discloses a telecommunications services portal linked to at least one mobile telecommunications network including at least one route navigation server coupled to a voice recognition interface in order to provide guidance information in real time, wherein in response to a destination which has been communicated to it by the user using a telecommunications terminal connected to said network, and wherein the navigation server includes means for acoustic analysis of the received signal.

GB 2 368 441 A discloses a voice to voice data handling system comprising a multiplicity of mobile, e.g. automobile borne, sub-systems linked to a remote internet server by way of individual GSM and GPRS facilities, wherein each sub-system has a hands-free facility and a microphone and speaker as well as a facility capable of recognizing a limited range of simple pre-programmed voice commands and otherwise to transmit the command to the Server.

EP 1 341 363 A1 discloses a system for interfacing a device onboard a vehicle and a voice portal server external to the vehicle including a voice communicator and a data communicator situated in the vehicle, wherein the onboard device communicates electronically with the voice communicator and/or the data communicator which in turn are able to communicate wirelessly with a base station, and wherein the base station communicates electronically with the voice portal server.

EP 1 739 546 A2 discloses an automotive system providing an integrated user interface for control and communication functions in an automobile or other type of vehicle, wherein the user interface supports voice enabled interactions, as well as other modes of interaction, such as manual interactions using controls such as dashboard or steering wheel mounted controls, wherein the system also includes interfaces to devices in the vehicle, such as wireless interfaces to mobile devices that are brought into the vehicle, and wherein the he system also provides interfaces to information sources such as a remote server for accessing information.

It is an object of the invention to improve the speech recognition within a motor vehicle. It is another object of the invention to improve the efficiency of a speech recognition within a motor vehicle during a restricted available access to a wireless communication link. It is a further object of the invention to use the bandwidth of a wireless communication link to a motor vehicle more efficiently.

### SUMMARY OF THE INVENTION

The above object is achieved by a speech recognition assembly for acoustically controlling a function of a motor vehicle, wherein the speech recognition assembly comprises a microphone disposed in the motor vehicle for inputting a voice command, a data base disposed in the motor vehicle in which respectively at least one meaning is associated to phonetic representations of voice commands and an on-board-speech-recognition-system disposed in the motor vehicle for determining a meaning of the voice command depending, for example, on the position of the motor vehicle or a selected position by use of a meaning of a phonetic representation of a voice command which is stored in the data base, wherein the speech recognition assembly further comprises an off-board-speech-recognition-system disposed spatially separated from the motor vehicle for determining a meaning of the voice command and a communication system for transmitting a voice command from the motor vehicle to the off-board-speech-recognition-system and for transmitting the meaning of the voice command transmitted to the off-board-speech-recognition-system which was determined by the off-board-speech-recognition-system and particularly a phonetic representation associated to the voice command from the off-board-speech-recognition-system to the motor vehicle, wherein the phonetic representation of the voice command transmitted to the off-board-speech-recognition-system can be stored in the data base together with its meaning determined by the off-board-speech-recognition-system.

A function of a motor vehicle in the sense of the invention is in particular the selection and/or search of a (target) location and/or an information.

A meaning of a voice command in the sense of the invention can be a meaning in a narrow sense. Thus, for example, the meaning of the voice command “Satkar Indian Restaurant” can be “Satkar Indian Restaurant”. A meaning of a voice command in the sense of the invention can also be a result associated to the meaning of the voice command in a narrow sense. Thus, for example, the meaning of the voice command “Indian Restaurant” among others can be “Satkar Indian Restaurant”. In this sense a phonetic representation of an actual voice command in the sense of the invention can be a phonetic representation of the actual voice command and/or a phonetic representation of the result associated to the voice command. The phonetic representation of the voice command transmitted to the off-board-speech-recognition-system can be a phonetic representation determined by the off-board-speech-recognition-system and transmitted to the motor vehicle.

“Stored together” or “can be stored together” in the sense of the invention should mean that the corresponding data are stored in relation to each other.

According to one embodiment of the invention a position allocated to the meaning of the voice command can be transmitted from the off-board-speech-recognition-system to the motor vehicle. A position in the sense of the invention can be a position in a narrow sense. However, a position in the sense of the invention particularly can comprise a certain area to which a meaning or a search result is allocated. Thus a position in the sense of the invention can comprise a city or a federal state or a district. However, a position in the sense of the invention can also comprise an area of a certain zip code area or an area comprising several cities. However, a position in the sense of the invention can also comprise an area defined by a circle (particularly having a certain radius) around a predetermined point. With respect to a restaurant a position in the sense of the invention, for example, can comprise a city in which the restaurant is located. An allocated position in the sense of the invention particularly is an area which is denoted as a position and in which the result of a search lies.

According to another embodiment of the invention the phonetic representation of the voice command transmitted to the off-board-speech-recognition-system can be stored in the data base together with its meaning determined by the off-board-speech-recognition-system and with the or a position allocated to the meaning. According to a further embodiment of the invention the speech recognition assembly comprises a navigation system arranged in the motor vehicle for determining the position of the motor vehicle.

The above object is further achieved by a method for acoustically controlling a function of a motor vehicle, wherein a voice command is inputted by a microphone disposed in the motor vehicle, wherein it is attempted by means of an on-board-speech-recognition-system arranged in the motor vehicle to determine a meaning of the voice command by use of a data base arranged in the motor vehicle in which respectively at least one meaning is associated to phonetic representations of voice commands, wherein the voice command is transmitted from the motor vehicle to an off-board-speech-recognition-system only if the meaning of the voice command could not be determined by means of the on-board-speech-recognition-system, wherein a meaning of the voice command transmitted to the off-board-speech-recognition-system which was determined by the off-board-speech-recognition-system and particularly a position allocated to this meaning are transmitted from the off-board-speech-recognition-system to the motor vehicle, wherein the phonetic representation of the voice command transmitted to the off-board-speech-recognition-system together with its meaning determined by the off-board-speech-recognition-system are stored in the data base, and wherein the function of the motor vehicle is controlled and performed, respectively, according to the determined meaning of the voice command.

According to one embodiment of the invention the phonetic representation of the voice command transmitted to the off-board-speech-recognition-system together with its meaning determined by the off-board-speech-recognition-system and with the or one position allocated to the meaning are stored in the data base. According to another embodiment of the invention the position of the motor vehicle is determined. In a further embodiment of the invention the meaning of the voice command is determined by means of the on-board-speech-recognition-system depending on the position of the motor vehicle.

The above object is further achieved by a motor vehicle comprising a microphone for inputting a voice command, wherein the motor vehicle comprises a data base in which respectively at least one meaning and a position are allocated to phonetic representations of voice commands and an on-board-speech-recognition-system for determining a meaning of the voice command particularly depending on the position of the motor vehicle by use of a meaning of a phonetic representation of a voice command stored in the data base.

According to one embodiment of the invention the motor vehicle comprises an interface for a wireless access to an off-board-speech-recognition-system which is spatially separated from the motor vehicle. According to another embodiment of the invention the phonetic representation of a voice command transmitted to the off-board-speech-recognition-system together with its meaning determined by the off-board-speech-recognition-system and a position allocated to the meaning is stored in the data base. In a further embodiment of the invention a function of the motor vehicle can be controlled or performed according to the meaning of the voice command determined by the off-board-speech-recognition-system.

A motor vehicle in the sense of the invention is particularly a surface vehicle usable individually in road traffic. Motor vehicles in the sense of the invention are not particularly limited to surface vehicles comprising internal combustion engines.

Further advantages and details become clear from the following description of embodiments:

### SHORT DESCRIPTION OF THE DRAWINGS

FIG. 1 shows an embodiment of a speech recognition assembly for acoustically controlling a function of a motor vehicle;

FIG. 2 shows an embodiment of a motor vehicle;

FIG. 3 shows an embodiment of a data base; and

FIG. 4 shows an embodiment of a method for controlling a motor vehicle.

### DETAILED DECRIPTION OF PREFERRED EMBODIMENTS

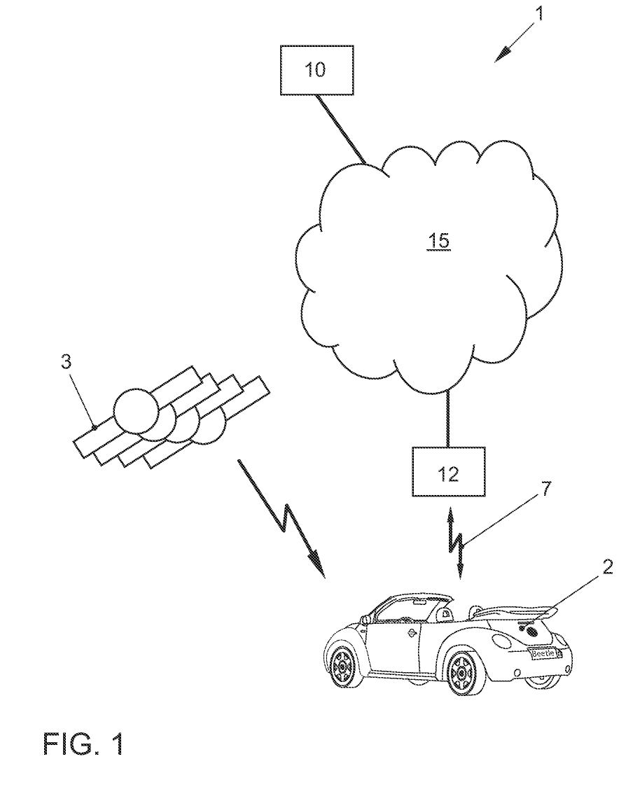

FIG. 1 shows an example embodiment of a speech recognition assembly 1 for acoustically controlling a function of a motor vehicle 2. The speech recognition assembly 1 comprises an off-board-speech-recognition-system 10 disposed externally from the motor vehicle 2 for determining a meaning of a voice command. The speech recognition assembly 1 further comprises a wireless internet link between the motor vehicle 2 and the off-board-speech-recognition-system 10 by which a voice command from the motor vehicle 2 is transmitted to the off-board-speech-recognition-system 10 and a meaning of the voice command transmitted to the off-board-speech-recognition-system which was determined by the off-board-speech-recognition-system 10 is transmitted from the off-board-speech-recognition-system 10 to the motor vehicle 2. For implementing the wireless internet link there is provided a wireless communication link 7 between the motor vehicle 2 and a communication node 12 for connecting to the internet 15. The wireless communication link is particularly a WLAN. The wireless communication link 7 can also be provided as WIFI-link, WIMAXI-link, RFI-link, mobile radio link and so forth. It is also possible to select (automatically) between alternative wireless communication links depending on certain criteria. These criteria, for example, are costs, availability and/or bandwidth.

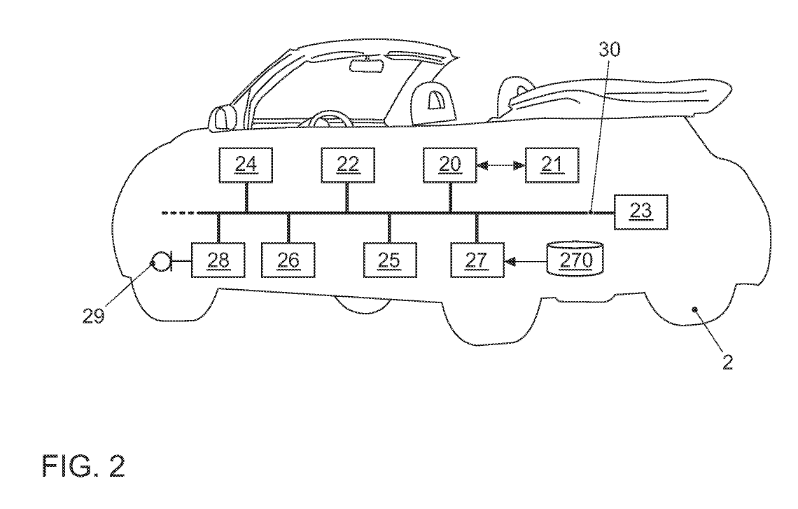

FIG. 2 shows a principle view of an example embodiment of an exemplary implementation of the motor vehicle 2. The motor vehicle 2 comprises a men-machine-interface 21 implemented, for example, as a touch screen including a display. The touch screen 21 can be driven by a display control 20 which is connected to an internet interface 22 for the wireless communication link 7 by means of a bus system 30. According to the present example embodiment the men-machine-interface 21 implemented as touch screen can also be used for controlling an infotainment system 24, a telephone set 25 or an automatic air conditioner 26.

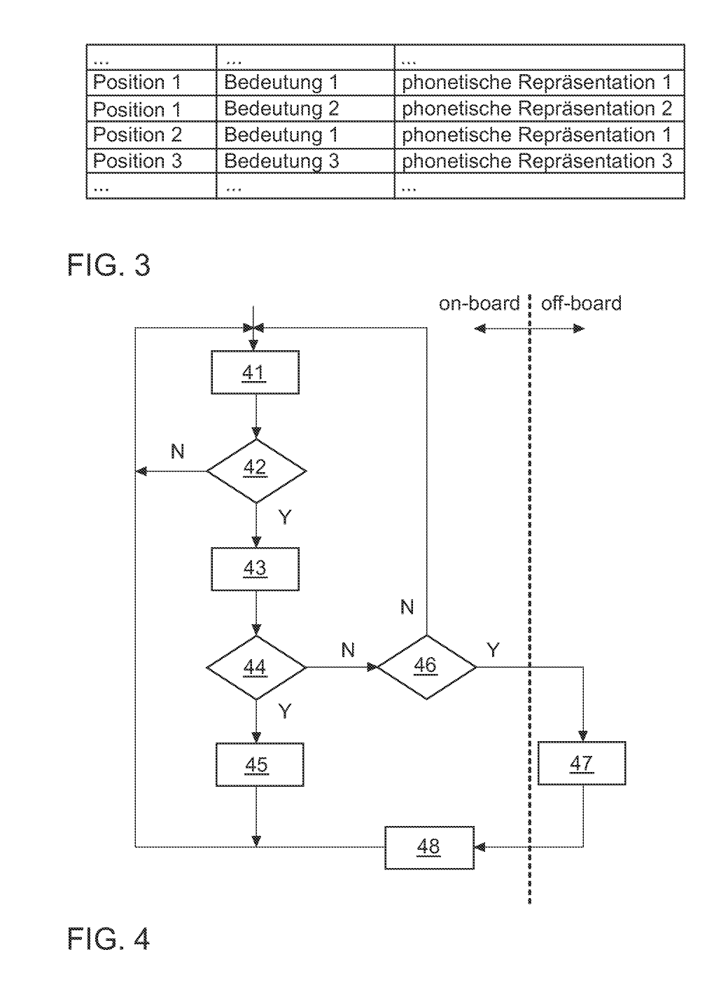

The motor vehicle 2 comprises a locating system integrated into a navigation system 23 for determining the position of the motor vehicle 2, determining the orientation of the motor vehicle 2 and/or determining the on-board time depending on signals transmitted from satellites indicated by reference symbols 3 in FIG. 1. A recommended route for the motor vehicle 2 to a destination can be determined by means of the navigation system 23. The motor vehicle 2 also comprises a microphone 29 for inputting voice commands which is coupled to the bus system 30 by a voice interface 28, a data base 270 in which—as partially exemplarily indicated in FIG. 3—respectively at least one meaning and one position are allocated to phonetic representations of voice commands, as well as an on-board-speech-recognition-system 27 for determining a meaning of a voice command by use of a meaning of a phonetic representation of a voice command stored in the data base 270. Further a speaker can be provided which also can be coupled to the bus system 30 by the voice interface 28.

FIG. 4 shows an example embodiment of a method of controlling a motor vehicle 2 and the speech recognition assembly 1, respectively. Herein at first in step 41 the entries which are allocated to the same position, for example, position 1 are loaded from the data base 270. Step 41 is followed by a query 42 whether a voice command has been entered. If no voice command has been entered step 41 is processed again. However, if a voice command has been entered query 42 is followed by step 43 in which it is attempted to recognize the voice command by means of the on-board-speech-recognition-system 27.

Step 43 is followed by a query 44 whether the voice command has been recognized (could be analysed) by means of the on-board-speech-recognition-system 27. If the voice command has been recognized by means of the on-board-speech-recognition-system 27 query 44 is followed by a step 45 in which a function of the motor vehicle corresponding to the voice command is executed. This for example can comprise displaying or outputting an information (such as a target location) or transmitting a target location to the navigation system 23. Step 45 again is followed by step 41. If on the other side the voice command has not been recognized by the on-board-speech-recognition-system 27 query 44 is followed by a query 46 whether the communication link 7 is available.

If the communication link 7 is not available query 46 is followed by step 41. If on the other side the communication link 7 is available the voice command is transmitted to the off-board-speech-recognition-system and is analysed there in step 47. The result of this analysis is a meaning of the voice command which can be a meaning in a narrow sense as well as the result of a search triggered by the meaning in the narrow sense. The meaning of the voice command (and the meaning in the narrow sense and the result, respectively) are transmitted together with a phonetic representation of the voice command and a position allocated to the meaning such as the name of a city and/or a zip code to the motor vehicle 2.

Then follows step 48 in which the data set including the meaning of the voice command (and the meaning in the narrow sense and the result, respectively), the phonetic representation of the voice command and the position allocated to the meaning are added to the data base 270. Furthermore a function of the motor vehicle corresponding to the voice command is executed.

The invention is further explained in terms of following examples: Assuming a user would engage the speech recognition system and speak “Indian Restaurant”, the audio is captured and coded in the vehicle embedded system, then formatted for transmission over an IP network. Example connection methods can include session-oriented TCP or HTTP request under a web services model. Audio data received at the off-board-speech-recognition-system 10 is then processed for various pieces of information, such as word recognition, language understanding, and data driven tuning. Furthermore, to enable information lookup and search on the internet itself, the extracted word meanings can be passed to information retrieval services (which are part of the off-board-speech-recognition-system in the meaning of the claims). Finally, a response is transmitted as data to the vehicle. The response includes (1) speech recognition representations of the query itself, (2) the locality of the search, and (3) the context-specific results from the search. The vehicle local embedded speech recognition system interprets these, performing format conversions if necessary, and stores all three pieces of information into its local cache (database 270). If future queries match the speech recognition representation of a previously cached query (saved in database 270) and are in the same locality of search as that previously cached query, then the system (on-board-speech-recognition-system 27) can return the context-specific results from that query without ever sending anything over the network or requiring the off-board-speech-recognition-system 10. This can be useful when there is either network downtime, temporarily disabling the networked speech system. It is also useful when faster searches, bandwidth conservation, and/or reduced server processing is desirable.

An example result set data file as shown in Table 1 would include the phonetic representation of “Indian Restaurant” (the query), the city of “Palo Alto, Calif.” (the locality), and a list of Indian food restaurants in Palo Alto, Calif. (the context-specific result set).

TABLE 1

<networked_speech_session>
<search_query>
<text>Indian Restaurant</text>
<phonetic>IH N D IY AH N . R EH S T ER AA N T .</phonetic>
<locality>
<city>Palo Alto</city>
<state>CA</state>
</locality>
</search_query>
<listing_result>
<biz_name>
<text>Satkar Indian Cuisine</text>
</biz_name>
<biz_listing>
<address>
<house_number>233</house_number>
<street>state</street>
<thoroughfare>street</thoroughfare>
<city>los altos</city>
<state>CA</state>
<zip>94022</zip>
</address>
</biz_listing>
</listing_result>
</networked_speech_session>

In the above example, the pronunciation of “Indian Restaurant” is added to the grammar of the local speech recognition system, along with “Palo Alto, Calif.”, which is the locality that the search was performed in. The next time that a search is performed that matches the pronunciation of “Indian Restaurant” and is in the locality of “Palo Alto, Calif.”, (e.g. if the vehicle is in Palo Alto) the system needs only return the cached contextual results (from database 270).

In an other example, a user would engage the speech recognition system and speak “Indian Food”. The audio is captured and coded in the vehicle embedded system, then formatted for transmission over an IP network. Example connection methods can include session-oriented TCP or HTTP request under a web services model. Audio data received at the off-board-speech-recognition-system 10 is then processed for various pieces of information, such as word recognition, language understanding, and data driven tuning. Furthermore, to enable information lookup and search on the internet work itself, the extracted word meanings can be passed to information retrieval services. Finally, results are transmitted as data to the vehicle (as explained above).

The results include context-specific speech recognition representations of words and phrases from the result set. The vehicle local embedded speech recognition system (on-board-speech-recognition-system 27) interprets these, performing format conversions of necessary, and includes the specific word and phrase representations in its grammar for the search task refinement. The vehicle embedded system can then perform additional speech recognition functions for search refinement that includes allowing the user to say context-specific words or phrases. Finally it presents the overall result information to the user. An example result set data file would include a list of Indian food restaurants and include contextspecific speech recognition representations of proper names from the result set. Table 2 shows an example of an unique listing within the results set.

TABLE 2
<listing_result>
<phonetic_format>basic</phonetic_format>
<biz_name>
<text>Satkar Indian Cuisine</text>
<tts>satkar indian cuisine</tts>
<phonetic string=”satkar” var=”1”>S AH T K AO R</phonetic>
<phonetic string=”satkar” var=”2”>S AA T K AA R</phonetic>
</biz_name>
<biz_listing>
<address>
<house_number>233</house_number>
<street>state</street>
<thoroughfare>street</thoroughfare>
<city>los altos</city>
<city_tts>los altos</city_tts>
<city_text>Los Altos</city_text>
<phonetic string=”los altos” var=”1”>L AA S | AE L T OW S</phonetic>
<state>CA</state>
<zip>94022</zip>
</address>
</biz_listing>
</listing_result>

The section “<phonetic_format>basic</phonetic_format>” describes the format of the phonetic representations of result words and phrases generated from the off-board-speech-recognition-system 10. The sections
“<phonetic string=“satkar” var=“1”>S AH T K AO R</phonetic>”
“<phonetic string=“satkar” var=“2”>S AA T K AA R</phonetic>” and
“<phonetic string=“los altos” var=“1”>L AA S|AE L T OW S</phonetic>”
   are phonetic representations of proper-name words and phrases in a local embedded speech recognizer dictionary format (i.e. for the on-board-speech-recognition-system 27). In the above example, the word “Satkar” from the listing named “Satkar Indian Cuisine” is associated with two possible pronunciations for the local embedded speech recognition system to interpret. The word phrase “Los Altos” is provided along with one pronunciation. The phonetic transcription format is identified as “basic.” Upon receiving this exemplary results file, the local embedded speech recognition system (on-board-speech-recognition-system 27) parses it appropriately, appends to its phonetic dictionary (in the database 270), and builds the context-specific local grammar for next-step interactions with the system. At this point, the speakable words would include all or combinations of: “Satkar Indian Cuisine” and “Los Altos” (given that “Indian” and “Cuisine” would already be part of a local plain-English dictionary).

The following exemplary embodiment depicts an overall view of an end-to-end search task. After the first-step interaction where voice search is conducted on the IP-addressable server, it loads a grammar in the local embedded speech recognition system that is used to recognize voice commands for search task refinement. This grammar now includes context-specific words and phrases such as “Satkar Indian Cuisine” and “Los Altos.” It could also include other proper names and partial proper names related to street location, city location, and related “keywords.” Upon the user's next interaction step with the combined speech recognition system, the embedded system can then analyze the recorded voice (at “List Matching Results-Embedded G2P or Networked”) using context-specific words and phrases without going back over the network for speech services.

LIST OF REFERENCE SYMBOLS

| | |
|---|---|
| 1 | Speech recognition assembly |
| 2 | Motor vehicle |
| 3 | Satellite |
| 7 | Communication link |
| 10 | Off-board-speech-recognition-system |
| 12 | Communication node |
| 15 | Internet |
| 16 | Terminal |
| 20 | Display control |
| 21 | Men-machine-interface |
| 22 | Internet interface |
| 23 | Navigation system |
| 24 | Infotainment system |
| 25 | Telephone |
| 26 | Automatic air conditioner |
| 27 | On-board-Speech-recognition-system |
| 28 | Voice Interface |
| 29 | Microphone |
| 30 | Bus system |
| 41, 43, 45, 47, | Step |
| 48 | |
| 42, 44, 46 | Query |
| 270 | Data base |

1. Speech recognition assembly for acoustically controlling a function of a motor vehicle, wherein the speech recognition assembly comprises:
a microphone disposed in the motor vehicle for inputting a voice command;
a data base disposed in the motor vehicle in which respectively at least one meaning is allocated to phonetic representations of voice commands;
an on-board-speech-recognition-system disposed in the motor vehicle for determining a meaning of the voice command by use of a meaning of a phonetic representation of a voice command which is stored in the data base;
an off-board-speech-recognition-system disposed spatially separated from the motor vehicle for determining a meaning of the voice command; and
a communication system for transmitting a voice command from the motor vehicle to the off-board-speech-recognition-system and for transmitting
a meaning of the voice command transmitted to the off-board-speech-recognition-system, wherein the meaning was determined by the off-board-speech-recognition-system and
a meaning of the associated phonetic representation
from the off-board-speech-recognition-system to the motor vehicle, wherein the phonetic representation together with the meaning of the voice command determined by the off-board-speech-recognition-system is storable in the data base.

2. Speech recognition assembly for acoustically controlling a function of a motor vehicle, wherein the speech recognition assembly comprises:
a microphone disposed in the motor vehicle for inputting a voice command;
a data base disposed in the motor vehicle in which respectively at least one meaning is allocated to phonetic representations of voice commands;
an on-board-speech-recognition-system disposed in the motor vehicle for determining a meaning of the voice command by use of a meaning of a phonetic representation of a voice command which is stored in the data base;
an off-board-speech-recognition-system disposed spatially separated from the motor vehicle for determining a meaning of the voice command; and
a communication system for transmitting a voice command from the motor vehicle to the off-board-speech-recognition-system and for transmitting
a meaning of the voice command transmitted to the off-board-speech-recognition-system and determined by the off-board-speech-recognition-system
from the off-board-speech-recognition-system to the motor vehicle, wherein a phonetic representation associated to the meaning together with the meaning of the voice command determined by the off-board-speech-recognition-system and a position allocated to the meaning is storable in the data base.

3. Speech recognition assembly for acoustically controlling a function of a motor vehicle, wherein the speech recognition assembly comprises:
a microphone disposed in the motor vehicle for inputting a voice command;
a data base disposed in the motor vehicle in which respectively at least one meaning is allocated to phonetic representations of voice commands;
an on-board-speech-recognition-system disposed in the motor vehicle for determining a meaning of the voice command by use of a meaning of a phonetic representation of a voice command which is stored in the data base;
an off-board-speech-recognition-system disposed spatially separated from the motor vehicle for determining a meaning of the voice command; and
a communication system for transmitting the voice command from the motor vehicle to the off-board-speech-recognition-system and for transmitting
a meaning of the voice command transmitted to the off-board-speech-recognition-system which was determined by the off-board-speech-recognition-system and
a position allocated to the meaning
from the off-board-speech-recognition-system to the motor vehicle.

4. Speech recognition assembly according to claim 3, wherein the meaning of the voice command determined by the off-board-speech-recognition-system together with the position allocated to the meaning is storable in the data base.

5. Speech recognition assembly according to claim 3, wherein a phonetic representation associated to the meaning is transmittable by means of the communication system from the off-board-speech-recognition-system to the motor vehicle.

6. Speech recognition assembly according to claim 5, wherein the phonetic representation associated to the meaning together with the meaning determined by the off-board-speech-recognition-system and a position allocated to the meaning is storable in the data base.

7. Method for acoustically controlling a function of a motor vehicle, wherein the method comprises the steps of:
inputting a voice command by a microphone disposed in the motor vehicle;
attempting to determine a meaning of the voice command by means of an on-board-speech-recognition-system arranged in the motor vehicle by use of a data base arranged in the motor vehicle, wherein in the data base at least one meaning is allocated to phonetic representations of voice commands;
transmitting the voice command from the motor vehicle to an off-board-speech-recognition-system if the meaning of the voice command cannot be determined by means of the on-board-speech-recognition-system;
determining a meaning of the voice command transmitted to the off-board-speech-recognition-system by mean of the off-board-speech-recognition-system;
transmitting the meaning from the off-board-speech-recognition-system to the motor vehicle;
transmitting at least one information of the group consisting of:
a phonetic representation associated to the meaning; and
a position allocated to the meaning;
from the off-board-speech-recognition-system to the motor vehicle; and
controlling the function of the motor vehicle according to the determined meaning of the voice command.

8. Method according to claim 7, further comprising:
storing the meaning together with the phonetic representation associated to the meaning into the data base.

9. Method according to claim 7, further comprising:
storing the meaning together with the position allocated to the meaning into the data base.

10. Method according to claim 7, wherein the meaning, the phonetic representation associated to the meaning and the position allocated to the meaning are transmitted from the off-board-speech-recognition-system to the motor vehicle.

11. Method according to claim 10, further comprising:
storing the meaning together with the phonetic representation associated to the meaning and the position allocated to the meaning into the data base.

12. Motor vehicle comprising:
a microphone for inputting a voice command;
a data base in which respectively at least one meaning and a position are allocated to phonetic representations of voice commands; and
an on-board-speech-recognition-system for determining a meaning of the voice command by use of a meaning of a phonetic representation of a voice command stored in the data base.

13. Motor vehicle according to claim 12, further comprising:
an interface for a wireless access to an off-board-speech-recognition-system which is spatially separated from the motor vehicle.

14. Motor vehicle according to claim 13, wherein the phonetic representation of a voice command transmitted to the off-board-speech-recognition-system together with its meaning determined by the off-board-speech-recognition-system and a position allocated to the meaning is stored in the data base.
